(19) United States
(12) Patent Application Publication
(10) Pub. No.: US 2019/0314832 A1
(43) Pub. Date: Oct. 17, 2019

(54) FLUID DISPENSER HAVING A DISCHARGE HEAD

(71) Applicant: APTAR RADOLFZELL GMBH, Radolfzell (DE)

(72) Inventor: Tobias BAUMANN, Konstanz (DE)

(21) Appl. No.: 16/314,704

(22) PCT Filed: Jul. 10, 2017
(86) PCT No.: PCT/EP2017/067299

§ 371 Date: Jan. 2, 2019

(30) Foreign Application Priority Data
Jul. 29, 2016 (EP) 16182017.0

(51) Int. Cl. B05B 1/34; B05B 1/30; B05B 11/00

(52) U.S. Cl. CPC B05B 1/3452; B05B 1/304; B05B 11/304; B05B 11/3001; B05B 1/3468

(57) ABSTRACT

A fluid dispenser having an accumulator and a discharge head. The discharge head is secured to a base unit of the dispenser, which base unit includes a fluid accumulator. The discharge head has a housing displaceable relative to the base unit for actuating the dispenser. The discharge head has an inlet through which fluid travels from the fluid accumulator into the discharge head, and a discharge opening through which the fluid is delivered into the atmosphere. A swirling chamber having an inlet channel is provided between the fluid inlet and the discharge opening so that inflowing fluid is provided with a swirl which forms a spray stream when exiting the discharge opening. The swirling chamber is switched between a first and a second configuration by changing the geometry of its walls and/or the inlet channel.

### FIELD OF APPLICATION AND PRIOR ART

The invention relates to a fluid dispenser according to the preamble of claim 1.

Generic fluid dispensers and their discharge heads serve for the purpose of delivering fluids in the form of a spray stream. This can relate in particular to cosmetic fluids, such as perfumes and the like, or to pharmaceutical fluids, such as remedies for insect stings for example, or foodstuffs, such as olive oil.

The generation of a spray stream requires high shear forces to be induced in the fluid, by means of which a fluid film or fluid flow is broken down into individual droplets. In the case of generic discharge heads, this takes place by means of a swirling chamber into which the fluid flows eccentrically through one or more inlet channels so that a rotating fluid flow is established in the swirling chamber, which is broken down as it exits through a discharge opening owing to the swirl and the kinetic energy.

With regard to many fluids, however, there is a wish to also discharge these in a non-atomized form, i.e. in the form of a jet/flow or in drop form.

Most of the discharge heads and fluid dispensers known from the prior art are designed for discharging fluid either in an atomized form or in the form of a jet/flow or in drop form.

### OBJECT AND SOLUTION

The object of the invention is to provide a fluid dispenser having a discharge head, which optionally enables discharging in an atomized form or in the form of drops or a jet/flow.

This object is achieved by a fluid dispenser which comprises a fluid accumulator for receiving fluid before the discharge procedure and a discharge head mounted thereon.

The fluid dispenser can possess a pump device, which can be actuated by a relative translative movement of the discharge head with respect to the base unit and conveys fluid from the fluid accumulator into the discharge head. Such a fluid dispenser possesses a fluid accumulator, in which the fluid is unpressurized. By pressing down the pump device, a pump chamber, which is preferably provided with pressure relief valves on the input side and output side, is volumetrically reduced so that the fluid is conveyed into the discharge head and in the direction of a swirling chamber and a discharge opening.

Alternatively, the fluid accumulator can be formed as a pressure accumulator and the fluid accumulator can possess a valve device, which can be actuated by a relative translative movement of the discharge head with respect to the base unit and conveys fluid from the fluid accumulator into the discharge head. In the case of such a design, pressing down the discharge head with respect to the fluid accumulator merely results in opening an outlet valve. The pressurization of the fluid is already in effect owing to the design of the fluid accumulator as a pressure accumulator so that, when the outlet valve is open, the fluid flows in the direction of the swirling chamber and the discharge opening.

The discharge head, which is provided for securing to the base unit of the fluid dispenser, has a housing which is preferably displaceable with respect to the base unit for the purpose of actuating the fluid dispenser. It has a fluid inlet, through which fluid to be discharged can make its way from the fluid accumulator into the discharge head, and has a discharge opening, through which the fluid can be delivered into a surrounding atmosphere.

A swirling chamber having at least one eccentrically leading inlet channel is provided between the fluid inlet and the discharge opening so that inflowing fluid can be provided with a swirl which brings about the formation of a spray stream as it exits the discharge opening.

The swirling chamber can be switched at least between a first and a second configuration by changing the geometry of walls of the swirling chamber and/or the at least one inlet channel. A handle is provided for manually switching between the configurations. In a first configuration, the fluid is delivered as a spray stream. In a second configuration, the fluid is delivered as a flow/jet. Designs are also possible in which there are further intermediate configurations.

The discharge head of a fluid dispenser according to the invention, which is used for transferring the fluid to be discharged from the inlet channel to the discharge opening, has, according to the invention, a swirling chamber which can be activated and deactivated manually, as it were, by the user of the fluid dispenser. If the swirling chamber is activated, owing to the geometry and relative arrangement of its walls, the swirling chamber itself, or an inlet channel penetrating the swirling chamber eccentrically and preferably tangentially, has a geometry which is suitable for inducing a swirl by means of which a spray cone is generated as the fluid exits through the discharge opening. By means of the handle, the user can switch to the second configuration in which fluid in the form of a continuous fluid flow/fluid jet or in drop form is delivered instead of a spray stream. In this second configuration, the walls of the swirling chamber and/or the shape of the inlet channel are changed in such a way that a swirl is no longer generated in the fluid or this swirl turns out to be so slight that it is insufficient for forming a spray stream.

Therefore, the user of the fluid dispenser can establish case by case whether he would like a product to be sprayed or whether he would like it to be released in the form of a fluid flow or drops. This is a useful option for example in areas of application such as the discharging of perfume or olive oil.

The change in the geometry of the swirling chamber and/or the inlet channel is preferably brought about in that the swirling chamber or the inlet channel is delimited by two swirling chamber components which are movable relative to one another. As a result of the manual actuation of the handle by the user, the relative position of these swirling chamber components is altered and, with this, the efficacy of the swirling chamber. Options for influencing the efficacy of the swirling chamber consist in particular in reducing the flow resistance into the swirling chamber through the relative movement of the swirling chamber components to prevent turbulence from forming and/or altering the eccentricity of the fluid inflow since the swirl can also be influenced in this way.

The swirling chamber components are preferably movable relative to one another in a translative manner, i.e. slidingly movable along a guide. For structural simplicity, it is in particular preferred if the swirling chamber components are linearly movable relative to one another.

A first swirling chamber component, in which a through-hole forming the discharge opening is preferably provided, is preferably provided, on an inner side, with a depression whereof the walls delimit the swirling chamber, and/or it is provided with a groove whereof the walls delimit the inlet channel into the swirling chamber. The second swirling chamber component has an end contact face which, in the first configuration, abuts against the first swirling chamber component so the contact face, together with the depression, delimits the swirling chamber and/or the contact face, together with the walls of the groove, forms the inlet channel.

The said configuration represents a very simple construction of the swirling chamber components. In this case, both swirling chamber components have mutually facing contact faces, which preferably result in a planar contact of the swirling chamber components with one another. At least one of these contact faces has depressions which form the swirling chamber itself and/or the at least one inlet channel flowing eccentrically into the swirling chamber. However, a design is also conceivable in which the depression forming the swirling chamber is provided on one of the swirling chamber components and the depression forming the inlet channel is provided on the other swirling chamber component. If the contact faces abut against one another, the inlet channel and the swirling chamber are circumferentially closed and therefore have a geometry which is suitable for forming the swirl within the fluid in the swirling chamber. If the two contact faces are remote from one another, a gap is therefore produced between them, through which fluid can flow directly and centrically into the swirling chamber, mostly bypassing the inlet channel, whereby the flow resistance which is associated therewith is normally reduced in the process. In this second configuration, the fluid preferably flows into the swirling chamber through the circumferentially produced annular gap.

It is essentially possible for either the swirling chamber component which comprises the discharge opening or the swirling chamber component which does not comprise the discharge opening to be that which is displaced with respect to the housing of the discharge head. However, a design is preferred in which the swirling chamber component provided with the discharge opening is formed to be stationary with respect to the housing or formed by the housing itself, whilst the displaceable swirling chamber component is an internal component of the discharge head, the position of which is preferably not visible from the outside in this case.

The discharge head, as a whole, can represent the handle for manually switching between the configurations. This is realized for example in a design in which the discharge head is mounted on a base such that it is relatively movable thereto and the mutual relative position of the swirling chamber components can be brought about by a relative displacement of the discharge head and the base.

In an alternative design, it is provided that a button for manually switching between the configurations is provided on the discharge head itself, which button is displaceable with respect to the housing of the discharge head and directly or indirectly influences the relative position of the swirling chamber components. A direct influence is realized if the button is formed to be stationary with respect to a swirling chamber component so that the displacement of the button likewise also brings about a displacement of one of the swirling chamber components with respect to the housing.

Alternatively, it can be provided that, between the button and the swirling chamber component, a gear is provided via which the movement of the button with respect to the housing is coupled to the movement of the swirling chamber component with respect to the housing. Such a gear can be formed for example by two inclined planes on sides of the button and on sides of the swirling chamber component, which planes slide against one another.

A restoring spring is preferably provided, which acts between the swirling chamber components so that the swirling chamber components constantly have a force applied to them in the direction of an end position and are displaced in opposition to the force of the restoring spring as a result of a force being applied to the button.

The restoring spring brings about that only one of the configurations, i.e. only one of the mutual relative positions of the swirling chamber components, is stable. The swirling chamber components therefore remain in the other, unstable configuration only whilst the user applies a force to the button. Such a design is in particular expedient if the button for switching between the configurations is mounted in the region of an actuating face of the discharge head to which a force can be intentionally applied in order to initiate a discharging of fluid. In the case of such a design, by applying a force to the said actuating face or the button adjacent thereto, the user can, at the same time, select the configuration for the discharge procedure and induce the discharge procedure.

Alternatively to a button which is provided on the discharge head and is displaceable with respect to the discharge head, in order to change the configuration of the discharge head it can, in a manner already described, also be provided that the discharge head is formed to be rotatable about an axis of rotation with respect to the base unit and a gear is provided, by means of which a rotational movement of the discharge head brings about a relative displacement of the swirling chamber components. The advantage of such a design is, in particular, that the movement for initiating a discharge procedure, usually the pressing-down of the discharge head, is separate from the movement for switching between the configurations by changing the relative displacement of the swirling chamber components. The user can therefore firstly change the configuration of the discharge head in a potentially very convenient and very precise manner and then trigger a discharge procedure according to the selected configuration by pressing down the discharge head.

The gear preferably comprises a guide element which is at an angle-dependent spacing from the axis of rotation or is provided on the base unit, and a guide slide which is in engagement with the guide element and which is provided on the base unit or on one of the swirling chamber components.

The angle-dependent spacing is preferably generated by a spiral sectional shape. If the guide slide slides along the guide element, it thus also changes its spacing from the axis of rotation and therefore induces a radial displacement. Alternatively, in the case of a radially fixed guide slide, the guide element could also undergo a radial displacement. This radial displacement can be used to displace one of the swirling chamber components radially.

### BRIEF DESCRIPTION OF THE DRAWING

Further advantages and aspects of the invention are revealed in the claims and in the description below of preferred exemplary embodiments of the invention, which are explained below with reference to the figures.

FIG. 1 shows a fluid dispenser according to the invention in an overall view.

FIGS. 2 and 3 show the discharge head of the dispenser of FIG. 1 in two sectional, perspective views.

FIGS. 4A and 4B and 5A and 5B each show, sectioned along two different planes, the discharge device of the dispenser of FIG. 1 in two varying configurations.

FIGS. 6A and 6B show a second variant of a discharge head for a fluid dispenser according to the invention.

FIGS. 7A and 7B show a third variant of a discharge head for a fluid dispenser according to the invention.

### DETAILED DESCRIPTION OF THE EXEMPLARY EMBODIMENTS

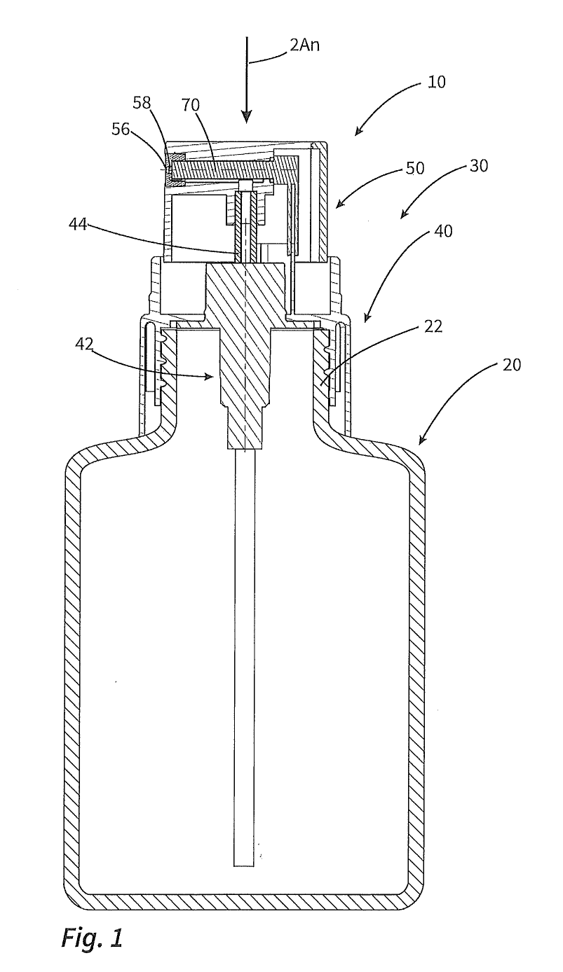

FIG. 1 shows a fluid dispenser 10 according to the invention in an overall view. This fluid dispenser 10 possess a fluid accumulator 20 and a discharge device 30, which is screwed to a neck 22 of the fluid accumulator 20.

The discharge device 30 in turn possesses a base 40, which is stationary with respect to the fluid accumulator, and a discharge head 50 which is provided on the base 40 and can be pressed down in an actuating direction 2A. An outlet control 42 in the form of a valve device or a pump device, which has an outlet connection 44 at its upper end, is furthermore provided on the base 40. Depending on the design, if this outlet connection 44 is pressed down in direction 2A, the outlet control 42 formed as a valve device is opened so that pressurized fluid can flow into the discharge head 50, or a pump procedure is brought about at the outlet control 42 formed as a pump device, so that fluid is conveyed from a pump chamber (not illustrated) into the discharge head and, upon a subsequent return stroke, the pump chamber is refilled from the fluid accumulator 20.

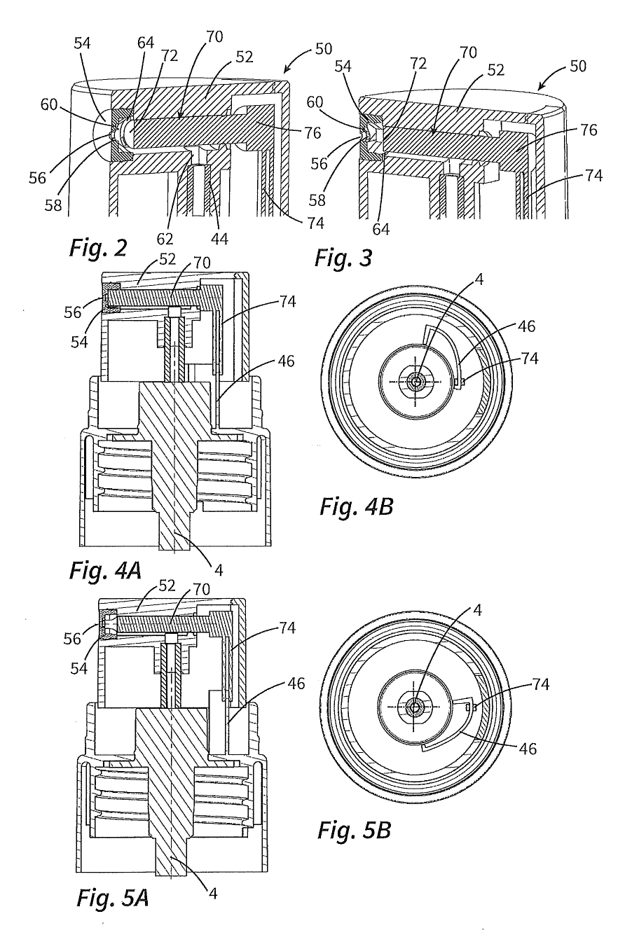

The discharge head 50 is also explained in more detail with reference to FIGS. 2 and 3. The discharge head 50 has a multi-part housing 52, which possesses a discharge opening 56 in a separate nozzle component 54. Connected upstream of the discharge opening 56 is a swirling chamber 58 into which tangentially aligned inlet channels 60 lead.

As a result, in the configuration of FIG. 4A, owing to an end face 72 of a plunger component 70 abutting against the nozzle component 54, fluid flowing into the discharge head at the fluid inlet 62 flows into the swirling chamber 58 through the tangential inlet channels 60 and is thereby provided with a swirl. This swirl brings about the production of a spray cone comprising tiny droplets of the fluid during the discharge procedure. This is the first possible configuration of the discharge head 50.

A second possible configuration is illustrated in FIG. 5A and furthermore also in the said FIGS. 2 and 3. In relation to the first configuration, the plunger component 70 in this second configuration is displaced in the radial direction to the right of the component 54 principally forming the swirling chamber. This brings about that the swirling chamber 58 itself and the inlet channel 60 flowing tangentially into it are each opened, as it were. In this case, the inlet channel 60 loses its function almost completely, since fluid can now flow into the swirling chamber via an annular gap 64. Therefore, a fluid swirl is also no longer formed to a relevant extent in the swirling chamber 58. Instead, the fluid is discharged through the discharge opening 56 as a non-atomized stream (jet).

FIGS. 4A and 4B on the one hand and FIGS. 5A and 5B on the other again illustrate the change in the relative position of the plunger component 70 with respect to the swirling chamber component 54. This refers in particular to the variation between the configurations. In FIG. 4A it can be seen that a flat web extending in the discharge head 50 is provided on the base 40, which web forms a guide element 46. As can be seen with reference to FIG. 4B, this guide element 46 does not surround the center axis 4 at a constant spacing but is instead designed in the form of a spiral section. This guide element 46 cooperates with a guide slide 74, which is provided at the rear end 76 of the plunger component 70. This cooperation between the guide element 46 and the guide slide 74 brings about that a rotation of the discharge head 50 with respect to the base 40 also brings about a radial displacement of the guide slide 74 in the manner illustrated by FIGS. 4B and 5B. This radial displacement simultaneously brings about the desired radial displacement of the plunger component 70 and its end face 72, so that the said configurations can be varied as a result of the rotational movement.

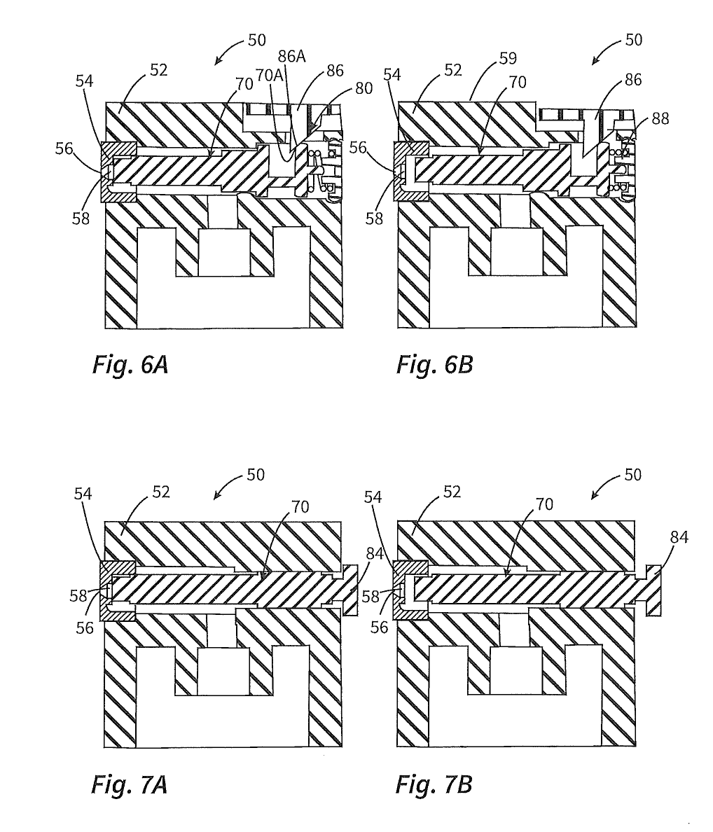

FIGS. 6A and 6B show a second variant, the mode of operation of which corresponds to the design described above in terms of activating and deactivating the generation of the spray stream by opening and closing the swirling chamber 58. However, deviating from the design described above, it is provided in this case that the plunger component 70 is pressed permanently in the direction of the configuration of 6A, i.e. the spray configuration, via a spring 88. To deflect the plunger component 70, a button 86 is provided which enables a deflection of the plunger component 70 in opposition to the force of the spring 88 via a gear 80 in the form of two planar portions 70A, 86A sliding against one another.

It is therefore possible to generate a non-atomized discharge stream by applying a pressing-down force to the discharge head in the region of the button 86. However, if the discharge head 50 has a force applied to it on the upper side 59 of the housing 52, adjacent to the button 86, a spray stream is generated.

In the design of FIGS. 7A and 7B, the construction is again simplified. In this case, a handle 84 is provided on the plunger component 70 at its rear end, which handle permits the two configurations for generating a spray stream or a non-atomized fluid stream by means of a pulling-out or pressing-in maneuver.

1. A fluid dispenser, in particular for discharging pharmaceutical or cosmetic fluids, having the following features:
a. the fluid dispenser has a base unit having a fluid accumulator for receiving fluid before the discharge procedure, and
b. the fluid dispenser has a discharge head which is provided for securing to the base unit, and
c. the fluid dispenser possesses a pump device, which can be actuated by a relative translative movement of the discharge head with respect to the base unit and conveys fluid from the fluid accumulator into the discharge head, or the fluid accumulator is formed as a pressure accumulator and the fluid dispenser possesses a valve device, which can be actuated by a relative translative movement of the discharge head with respect to the base unit and conveys fluid from the fluid accumulator into the discharge head, and
d. the discharge head has a housing, which is preferably displaceable with respect to the base unit for the purpose of actuating the fluid dispenser, and
e. the discharge head has a fluid inlet, through which fluid to be discharged can make its way from the fluid accumulator into the discharge head, and
f. the discharge head has a discharge opening, through which the fluid can be delivered into a surrounding atmosphere, and
g. a swirling chamber having at least one eccentrically leading inlet channel is provided between the fluid inlet and the discharge opening so that inflowing fluid is provided with a swirl which brings about the formation of a spray stream as it exits the discharge opening,
h. the swirling chamber can be switched between at least a first and a second configuration by changing the geometry of walls of the swirling chamber and/or the at least one inlet channel, and
i. the discharge head has a handle for manually switching between the configurations.

2. The fluid dispenser as claimed in claim 1, having the following feature:
a. the swirling chamber and/or the inlet channel is delimited by two swirling chamber components which are movable relative to one another.

3. The fluid dispenser as claimed in claim 2, having the following feature:
a. the swirling chamber components are movable relative to one another in a translative manner, in particular preferably linearly movable.

4. The fluid dispenser as claimed in claim 2, having the following features:
a. a first swirling chamber component is provided, on an inner side, with a depression whereof the walls delimit the swirling chamber, and/or is provided with a groove whereof the walls delimit the inlet channel into the swirling chamber, and
b. the second swirling chamber component has a contact face which, in the first configuration, abuts against the first swirling chamber component so that the contact face, together with the depression, delimits the swirling chamber and/or the contact face, together with the walls of the groove, forms the inlet channel.

5. The fluid dispenser as claimed in claim 4, having the following feature:
a. the first swirling chamber component has the discharge opening.

6. The fluid dispenser as claimed in claim 4, having the following feature:
a. in the second configuration, the first swirling chamber component and the second swirling chamber component are spaced from one another by a circumferential annular gap through which fluid can flow in the direction of the discharge opening.

7. The fluid dispenser as claimed in claim 2, having the following features:
a. the first swirling chamber component is part of the housing and
b. the second swirling chamber component is formed as a component which is displaceable with respect to the housing.

8. The fluid dispenser as claimed in claim 2, having the following features:
a. a button is provided for manual actuation, by means of which the relative position of the two swirling chamber components can be altered, and
b. the button is provided directly on one of the swirling chamber components.

9. The fluid dispenser as claimed in claim 2, having the following features:
a. a button is provided for manual actuation, by means of which the relative position of the two swirling chamber components can be mutually altered, and
b. the button is coupled to one of the two swirling chamber components by means of a gear.

10. The fluid dispenser as claimed in claim 8, having the following feature:
a. a restoring spring is provided, which acts between the swirling chamber components so that the swirling chamber components constantly have a force applied to them in the direction of an end position and are displaced in opposition to the force of the restoring spring as a result of a force being applied to the button.

11. The fluid dispenser as claimed in claim 1, having the feature:
a. the button for the relative displacement of the swirling chamber components with respect to one another is provided on a side of the discharge head which is remote from the base unit.

12. The fluid dispenser as claimed in claim 11, having the following feature:
a. the button is movable with respect to the housing of the discharge head in a direction which corresponds to the relative translative movement direction of the discharge head with respect to the base unit.

13. The fluid dispenser as claimed in claim 1, having the additional features:
a. the discharge head is formed to be rotatable about an axis of rotation with respect to the base unit, and
b. a gear is provided, by means of which a rotational movement of the discharge head brings about a relative displacement of the swirling chamber components.

14. The fluid dispenser as claimed in claim 13, having the following features:
a. the gear comprises a guide element, which is at an angle-dependent spacing from the axis of rotation and is provided on a swirling chamber component of the discharge head or on the base unit, and
b. the gear comprises a guide slide, which is in engagement with the guide element and is provided on the base unit or on one of the swirling chamber components.
